(19) United States
(12) Patent Application Publication
(10) Pub. No.: US 2012/0203401 A1
(43) Pub. Date: Aug. 9, 2012

(54) Onboard Maintenance System Network Optimization

(76) Inventors: Jonathan Mark Dunsdon, Evesham (GB); Mark Thomson, Kentwood, MI (US)

(21) Appl. No.: 13/022,806

(22) Filed: Feb. 8, 2011

(51) Int. Cl. G06F 19/00; H04B 1/44

(52) U.S. Cl. 701/3; 370/282

(57) ABSTRACT

An aircraft communication system includes an aircraft component, an Integrated Modular Avionics (IMA) unit, an Onboard Maintenance System (OMS), and a switch. The switch routes data provided by the aircraft component via a first communications protocol to the IMA unit, and mirrors the routed data to the OMS via a second communications protocol. The OMS processes and stores the received data, part of the received data, or the results of said processing.

### BACKGROUND OF THE INVENTION

Modern aircraft include an aircraft communications network for transferring data generated by sensors on aircraft components (e.g., altimeters, engines, landing gear, flaps, inclinometers, etc.) to an Integrated Modular Avionics (IMA) unit or cabinet on the aircraft. The aircraft communications network also transfers commands from the IMA unit to aircraft components. To pass the demanding tests aircraft are subjected to, the communications network on the aircraft uses ARINC 664 part 7 communications protocol or a derivative thereof such as Airbus's trademarked Avionics Full Duplex Switched Ethernet (AFDX). These communications protocols require switches and network components specific to the protocol.

Aircraft designers and engineers collect data from aircraft in service in order to refine the aircraft and guide future designs. The collected data is also used by the original equipment manufacturer, operator, and maintenance personnel to support maintenance operations on the aircraft. The data is collected and stored in an Onboard Maintenance System (OMS). One method for getting the data to the OMS includes running applications on the IMA unit of the aircraft which extract data and send it to the OMS for storage. This requires additional General Processing Modules (GPMs) in the IMA unit and adds traffic to the existing aircraft communications network which may already be near or at capacity.

### BRIEF DESCRIPTION OF THE INVENTION

In one embodiment, an aircraft communication system includes an aircraft component, an IMA unit, an OMS, and a switch. The switch routes data provided by the aircraft component to the IMA unit, and mirrors the routed data to the OMS.

In another embodiment, an aircraft communications switch includes a switching fabric and a port. The switching fabric routes data from an origin to a first destination (e.g. an IMA unit) via a first communications protocol. The port provides the routed data to a second destination (e.g., an OMS) via a second communications protocol.

In another embodiment, a method of communicating data on board an aircraft begins with providing data from an aircraft component to a switch. The provided data is routed from the switch to an Integrated Modular Avionics unit of the aircraft and mirrored from the switch to an OMS of the aircraft.

### BRIEF DESCRIPTION OF THE DRAWINGS

These and other features, aspects, and advantages of the present invention will become better understood when the following detailed description is read with reference to the accompanying drawings in which like characters represent like parts throughout the drawings.

FIG. 1 is a block diagram of an aircraft communication system according to an embodiment of the invention.

FIG. 2 is a block diagram of a method for communicating data on board an aircraft according to an embodiment of the invention.

Unless otherwise indicated, the drawings provided herein are meant to illustrate key inventive features of the invention. These key inventive features are believed to be applicable in a wide variety of systems comprising one or more embodiments of the invention. As such, the drawings are not meant to include all conventional features known by those of ordinary skill in the art to be required for practice of the invention.

### DETAILED DESCRIPTION

In the following specification and the claims, reference will be made to a number of terms, which shall be defined to have the following meanings

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about” and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

In one embodiment, an Onboard Maintenance System (OMS) is not critical to the in flight operation of an aircraft. Therefore, data transmission to the OMS may permit some level of packet loss not permissible with other systems such as an Integrated Modular Avionics (IMA) unit of the aircraft. Therefore, lower integrity communications may be used to transmit data from systems of the aircraft to the OMS. Further, because the OMS is not part of the IMA unit, which is considered critical to the in flight operation of the aircraft, data stored therein is not subject to the strict requirements of the IMA unit and lower integrity, higher volume storage media may be used.

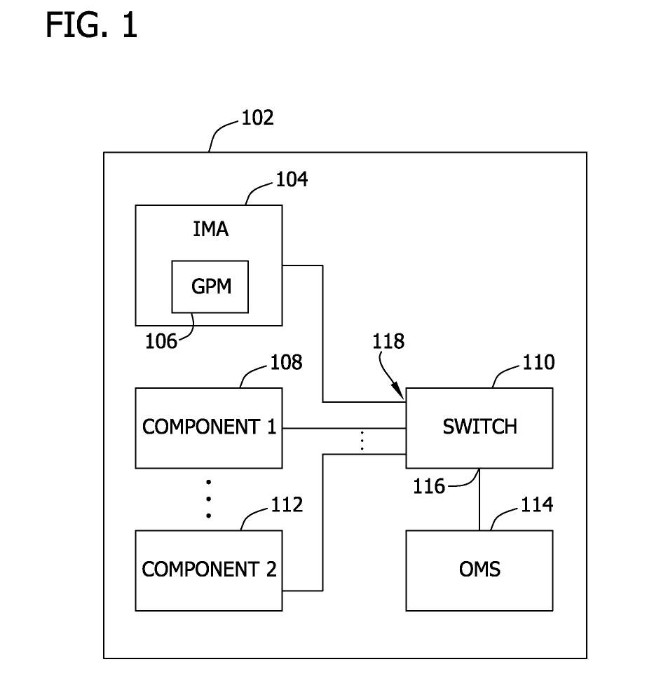

Referring to FIG. 1, an aircraft communications system 102 includes an IMA unit 104, a plurality of aircraft components (i.e., a first aircraft component 108 and a second aircraft component 112), a switch 110, and an OMS 114. The aircraft components 108 and 112 send data to the IMA unit 104 via a switch 110 and a first communications protocol such as ARINC 664 part 7 protocol at 100 megabits per second. In one embodiment, the data includes fault data, parametric data, and operating condition data. Additional first communications protocols are contemplated to be within the scope of the invention such as the Avionics Full Duplex Switched Ethernet (AFDX) which is owned by and a trademark of Airbus.

The switch 110 receives the data, routes the data via an internal switching fabric utilizing the first communications protocol, and sends the data to the IMA unit 104 via a plurality of ports 118 operating on the first communications protocol. A General Processing Module (GPM) 106 of the IMA unit 104 processes the data and may return commands to the aircraft components 108, 112 via the switch 110 and the first communications protocol.

The switch 110 also includes a port 116 communicating via a second communications protocol with the OMS 114. In one embodiment, the second communications protocol is Institute of Electrical and Electronics Engineers (IEEE) 802 at 1 gigabit per second. Other second communications protocols are contemplated within the scope of the invention such as IEEE 802 at 100 megabit per second and other IEEE 802.3 variants, particularly IEEE 802.3ab, depending on the amount of data to be transmitted to the OMS 114.

In one embodiment, the switch 110 mirrors all data having an aircraft component 108, 112 as an origin and the IMA unit 104 as the destination to the OMS 114. In another embodiment, the switch 110 mirrors all received packets containing data to the OMS 114. In one embodiment, the OMS 114 stores all of the received data, while in other embodiments, the OMS 114 processes the data and stores only a selected portion of the received data, processes the data and stores only the results of said processing, or stores the data in a lossless compressed format. In one embodiment, the data is stored on a solid state memory device such as a Secure Digital (SD) memory card. In one embodiment, the OMS 114 stores the data for the last 100 flight operations of the aircraft.

It is contemplated that multiple switches may simultaneously mirror data to the OMS 114 and that a switch utilizing the second communications protocol in its switching fabric may be used to route the data to the OMS 114.

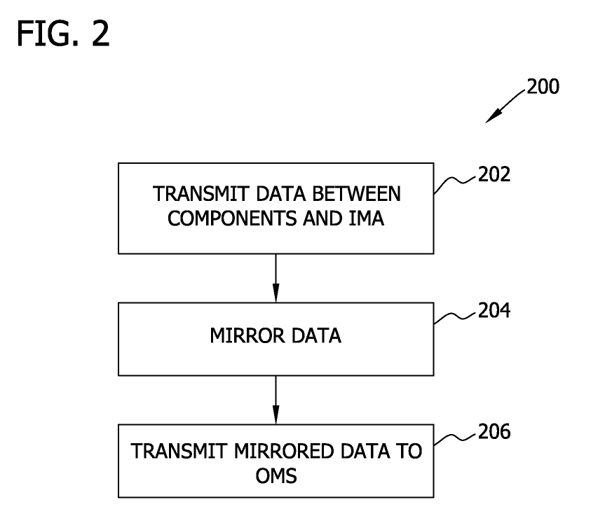

Referring to FIG. 2, a method of communicating data on board an aircraft 200 begins at 202. At 202, an aircraft component transmits data to an IMA unit of the aircraft via a switch and a first communications protocol. At 204, the switch mirrors the received data, and at 206, the switch transmits the received data to an OMS of the aircraft via a second communications protocol.

Exemplary embodiments of systems and methods for aircraft communications systems are described above in detail. The system and methods are not limited to the specific embodiments described herein, but rather, components of systems and/or steps of the method may be utilized independently and separately from other components and/or steps described herein.

Although specific features of various embodiments of the invention may be shown in some drawings and not in others, this is for convenience only. Moreover, references to “one embodiment” in the above description are not intended to be interpreted as excluding the existence of additional embodiments that also incorporate the recited features. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An aircraft communication system comprising:
an aircraft component configured to provide data;
an Integrated Modular Avionics unit configured to receive the provided data;
an Onboard Maintenance System configured to receive the provided data; and
a switch configured to:
receive the data provided by the aircraft component,
route the provided data to the Integrated Modular Avionics unit, and
mirror the provided data to the Onboard Maintenance System.

2. The aircraft communication system of claim 1 wherein the switch is configured to route the data from the aircraft component to the Integrated Modular Avionics unit via a first communications protocol and mirrors the data to the Onboard Maintenance System in a second communications protocol.

3. The aircraft communication system of claim 1 wherein the first communications protocol is ARINC 664 part 7 or Avionics Full Duplex Switched Ethernet at 100 megabits per second.

4. The aircraft communication system of claim 1 wherein the second communications protocol is Institute of Electrical and Electronics Engineers (IEEE) 802 at 1 gigabit per second.

5. The aircraft communication system of claim 1 wherein the Integrated Modular Avionics unit is further configured to provide commands to the aircraft component via the switch.

6. The aircraft communication system of claim 1 wherein the Onboard Maintenance System is configured to store the data mirrored to the Onboard Maintenance System by the switch for up to 100 flights of an aircraft comprising the aircraft communication system.

7. An aircraft communications switch comprising:
a switching fabric configured to route data via a first communications protocol from an origin to a first destination; and
a port configured to provide routed data to a second destination via a second communications protocol.

8. The aircraft communications switch of claim 7 wherein the first communications protocol is ARINC 664 part 7 or Avionics Full Duplex Switched Ethernet at 100 megabits per second.

9. The aircraft communications switch of claim 7 wherein the second communications protocol is Institute of Electrical and Electronics Engineers (IEEE) 802 at 1 gigabit per second.

10. The aircraft communications switch of claim 7 wherein the origin is an aircraft component.

11. The aircraft communications switch of claim 7 wherein the destination is an Integrated Modular Avionics unit

12. The aircraft communications switch of claim 7 wherein the first destination is an Integrated Modular Avionics unit configured to provide commands to the origin via the switching fabric.

13. The aircraft communications switch of claim 7 wherein the second destination is an Onboard Maintenance System configured to store data mirrored to the Onboard Maintenance System via the port for up to 100 flights of an aircraft comprising the aircraft communications switch.

14. A method of communicating data on board an aircraft, said method comprising:
providing data from an aircraft component to a switch;
routing the provided data from the switch to an Integrated Modular Avionics unit of the aircraft; and
mirroring the provided data from the switch to an Onboard Maintenance System of the aircraft.

15. The method of claim 14 wherein the switch is configured to route the data from the aircraft component to the Integrated Modular Avionics unit via a first communications protocol and mirror the data to the Onboard Maintenance System in a second communications protocol.

16. The method of claim 14 wherein the first communications protocol is ARINC 664 part 7 or Avionics Full Duplex Switched Ethernet at 100 megabits per second.

17. The method of claim 14 wherein the second communications protocol is Institute of Electrical and Electronics Engineers (IEEE) 802 at 1 gigabit per second.

18. The method of claim 14 wherein the origin is an aircraft component.

19. The method of claim 14 wherein the destination is an Integrated Modular Avionics unit

20. The method of claim 14 wherein the Integrated Modular Avionics unit is configured to provide commands to the aircraft component via the switch, and the Onboard Maintenance System is configured to store data mirrored to the Onboard Maintenance System by the switch for up to 100 flights of an aircraft comprising the aircraft communication system.
